(19) United States
(12) Patent Application Publication
(10) Pub. No.: US 2024/0393566 A1
(43) Pub. Date: Nov. 28, 2024

(54) OPTICAL ASSEMBLY THAT OPERATES AT EXTREME TEMPERATURES AND RAPID TEMPERATURE TRANSIENTS

(71) Applicant: PLX, Inc., Deer Park, NY (US)

(72) Inventor: Itai Vishnia, Setauket, NY (US)

(21) Appl. No.: 18/672,332

(22) Filed: May 23, 2024

Related U.S. Application Data
(60) Provisional application No. 63/503,848, filed on May 23, 2023.

(51) Int. Cl. G02B 7/18; G02B 27/00

(52) U.S. Cl. CPC G02B 7/181; G02B 27/0012

(57) ABSTRACT

A method for making an optic that is operable in extreme temperature environments, including selecting a material for each of a plurality of mirror panels based on one or more parameters, selecting a type of assembly of an optic, selecting a geometric configuration for each of the plurality of mirror panels, aligning optically each of the plurality of mirror panels, and assembling each of the plurality of mirror panels in optical alignment such that each mirror panel is within a predetermined angular tolerance. The assembling can include fusing the material of at least one of the plurality of mirror panels to make the optic of the selected type of assembly.

### CROSS REFERENCE TO RELATED APPLICATIONS

This application is entitled to and hereby claims priority under 35 U.S.C. § 119 (e) to provisional U.S. patent application Ser. No. 63/503,848, filed May 23, 2023, titled, “Optical Assembly to Operate at Extreme Temperatures and Rapid Temperature Transients,” which is hereby incorporated herein in its entirety.

### TECHNICAL FIELD

The present disclosure relates generally to optics, optical systems, and laser technologies, and more particularly to an optical system and optical assembly for operation under very adverse temperature conditions, such as, for example, those encountered in a fusion reactor diagnostic station, industrial smokestack, volcano monitoring station, or a furnace tester.

### BACKGROUND

Optical components and optical assemblies are critically important in metrology and, especially, interferometry applications such as those used in fusion reactor diagnostics, industrial smokestacks, volcano monitoring, furnace testing, among others, where temperatures can exceed over 1000° C. A significant challenge of state-of-the-art (“SOTA”) optical components and assemblies in such high temperature environments is that they often must be operable at, or below, room temperature, and all temperatures up to, and including, at least 1000° C. The inventors have found that SOTA optical components and assemblies have temperature limits that make them faulty or inoperable in such harsh environments, often going out of optical alignment, experiencing deformation, or otherwise becoming inoperable for their intended purposes; and, in severe cases, melting, cracking, or burning.

### SUMMARY

The present disclosure provides a technological solution to the problem of operating optical components and assemblies in very adverse temperature conditions, such as, for example, those encountered in fusion reactor diagnostic stations, industrial smokestacks, volcano monitoring or furnace testing. The technological solution provides a methodology for designing and making optical components and assemblies that can operate at temperatures ranging from below room temperature to at least 1000° C., including rapid transients that can cause temperature gradients across an optical component or assembly.

According to an aspect of the disclosure, a method is provided for making an optic that is operable in extreme temperature environments. The method includes: selecting a material for each of a plurality of mirror panels based on a parameter comprising at least one of a thermal diffusivity, a thermal conductivity, a specific heat, chemistry, and polishability; selecting a type of assembly of an optic; selecting a geometric configuration for each of the plurality of mirror panels; aligning optically each of the plurality of mirror panels; and assembling each of the plurality of mirror panels in optical alignment such that each mirror panel is within a predetermined angular tolerance, wherein the assembling further comprises fusing the material of at least one of the plurality of mirror panels to make the optic of the selected type of assembly.

According to another aspect of the disclosure, a method is provided for making an optic that is operable in extreme temperature environments, wherein the method includes selecting a material for each of a plurality of parts of an optic based on a parameter comprising at least one of a thermal diffusivity, a thermal conductivity, a specific heat, chemistry, and polishability; selecting a type of assembly of the optic; selecting a geometric configuration for each of the plurality of parts of the optic; aligning optically each of the plurality of parts of the optic; and assembling each of the plurality of parts of the optic in optical alignment such that each part is within a predetermined angular tolerance, wherein the assembling further comprises fusing the material of at least one of the plurality of parts of the optic to form the selected type of assembly of the optic.

Each of the plurality of parts of the optic can include a joining edge.

The fusing can include a continuous fused line along the joining edge of the at least one of the plurality of parts.

The fusing can include one or more discrete fused spots along the joining edge of the at least one of the plurality of parts.

The selected type of assembly can include a monolithic structure.

The assembling can include fusing the material of the at least one of the plurality of parts of the optic to form the monolithic structure.

The assembling can include fusing a joining edge of the connecting mechanism to another part of the plurality of parts of the optic to form the selected type of assembly of the optic.

The material can be selected based on the thermal diffusivity, the thermal conductivity, the specific heat, the chemistry, and the polishability.

The at least one of the plurality of parts of the optic can include a connecting mechanism. The connecting mechanism can include a connecting plate having a square-shape cross section. The connecting mechanism can include a connecting plate having a rectangular-shape cross section. The connecting plate can include a plurality of mounting features. The connecting mechanism can have cross-section having a shape other than a square, triangle, or rectangle shape.

The joining edge can include a beveled contact surface.

The joining edge can include a non-beveled contact surface. The non-beveled contact surface can include a non-mirror portion of first one of the plurality of parts of the optic. At least one of the plurality of parts of the optic can be a mirror panel.

The plurality of parts can include three mirror panels.

The one of the plurality of parts of the optic can be a mirror panel and the non-beveled portion can include a planar contact surface perpendicular to a mirror face of the mirror panel.

In the method, each of the plurality of parts of the optic can include a joining edge, the selected type of assembly can be a monolithic structure, and the assembling step can include fusing the material of each of the plurality of parts of the optic at the joining edge to form the monolithic structure.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a monolithic part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 is an illustration of an optical component having a symmetrical joint, constructed according to the principles of the disclosure.

FIG. 2 is an illustration of an optical component having a non-symmetrical joint, constructed according to the principles of the disclosure.

FIG. 3 is an illustration of an optical component having a structural plate, constructed according to the principles of the disclosure.

FIG. 4 is an illustration of an optical component with another embodiment of a structure plate, constructed according to the principles of the disclosure.

FIG. 5 is an illustration of a process for designing and constructing an optical component or optical assembly, according to the principles of the disclosure.

The present disclosure is further described in the detailed description that follows.

### DETAILED DESCRIPTION

The disclosure and its various features and advantageous details are explained more fully with reference to the non-limiting embodiments and examples that are described or illustrated in the accompanying drawings and detailed in the following description. It should be noted that features illustrated in the drawings are not necessarily drawn to scale, and features of one embodiment can be employed with other embodiments as those skilled in the art would recognize, even if not explicitly stated. Descriptions of well-known components and processing techniques may be omitted so as to not unnecessarily obscure the embodiments of the disclosure. The examples are intended merely to facilitate an understanding of ways in which the disclosure can be practiced and to further enable those skilled in the art to practice the embodiments of the disclosure. Accordingly, the examples and embodiments should not be construed as limiting the scope of the disclosure. Moreover, it is noted that like reference numerals represent similar monolithic parts throughout the several views of the drawings.

The technological solution of the instant disclosure provides a methodology for designing and constructing optical components and optical assemblies for operation in very adverse temperature conditions, such as those encountered in fusion reactor diagnostic stations, industrial smokestacks, volcano monitoring or furnace testing. For ease of reference, optical components and optical assemblies, individually and collectively as a system, are sometimes referred to herein as “optics.” The temperatures can range from 200° C. to at least 1000° C. in such environments. The technological solution also provides a methodology for the design and construction of optics for operation at, or below, room temperature, and the full range of temperatures up to at least 1000° C. While the drawings illustrate embodiments of optics having flat mirror panels for simplicity, the instant disclosure is equally applicable to optics that include optical components other than flat mirror panels.

SOTA optics have temperature limits due to their designs and construction, making the optics susceptible to stresses and strains resulting from differential thermal expansion. SOTA optics can experience material faults or failure under such conditions, including, for example, deformation, melting, cracking, or burning of optical components. Rapid transients are an issue for operability of optics because they can cause a temperature gradient across an optic, and, even if everything has the same coefficient of thermal expansion, the different temperatures can cause differential expansion, causing stress and distortion in the optic. Moreover, optical coatings that might be applied or included on optics typically cannot withstand such extreme temperatures or temperature variations.

The technological solution includes a methodology for selecting and assembling combinations of choice of material, assembly technology, component symmetry, component geometry, connecting mechanisms, and mounting features. Regarding choice of material, it is easy to suggest using materials that withstand elevated temperatures. However, there are other parameters that need to be factored into the choice of material. Depending on the range and the rate of change of temperatures the optics will need to operate under, the material can be selected based on its thermal diffusivity, specific heat, thermal conductivity, chemical reactivity at high temperature, and whether the material can be polished to an optical finish. Since optical coatings may not withstand such extreme temperatures or temperature variations, it is important that the material can be polished to an optical finish. Certain applications may require additional parameters to be considered.

Along with the choice of material, the technology and methodology implemented for assembling the optics is important. Assembly of optics to withstand elevated temperatures is tricky since, as temperature changes, fasteners will undergo expansion or contraction and, resultantly, change clamping forces on fastened parts, working or becoming loose under varying temperature conditions. The methodology includes fusing the materials of the optics to each other or to a common support to become a complete monolithic structure. Thus, the assembly can be constructed without need of SOTA fasteners, such as, for example, screws or retaining rings. The material fusion can include one or more discrete fusion spots along joining edges, or it can include a continuous line of fusion between the joining edges.

The methodology includes designing and constructing optics for component symmetry, which is a major tool that can be implemented to minimize thermal gradients in optics. At high temperatures, differences in shape or geometry in an optical component, or its inclusion in an optical assembly, can affect the flow of heat in and out of component(s), causing significant differences in temperature in or on parts of individual optics. Such differences translate into different thermal expansion and, thus, result in stress and deformation of optics that can manifest into component faults or failures.

The methodology also includes designing and constructing optics for optimal geometry in optical assemblies. Optics such as, for example, mirror panels, can adjoin or connect in a variety of geometries. In various embodiments of optics that include mirror panels, a preferred implementation is to have the mating faces of adjoining panels be at a 45-degrees angle to the polished surfaces. This is referred to as a miter joint. The miter joint provides component symmetry of the optics, which in the embodiments comprising mirror panels, provides component symmetry for each of the mirror panels. In certain embodiments of the optics, one or more joints between optical components can be butt-joined (using butt-joints) or half-lapped (using half-laps), neither which are considered symmetrical.

Connecting mechanisms are another factor of the technological solution. According to the methodology, connecting mechanisms, such as, for example, plates, wedges, or other structures, can be configured to connect or facilitate connection of two or more optics to each other in specific areas to promote heat transfer and minimize thermal gradients in the optics. The connecting mechanisms need not be a part of the optic but can be included for helping to achieve a thermal equilibrium.

The technological solution can also include mounting features, such as, for example, holes (threaded or otherwise) or protrusions (for example, a portion of a component configured) for insertion into corresponding one or more holes. When mounting features cannot be avoided, the methodology includes positioning and placing one or more mounting features in the optic to avoid any possible hot spots, since a mounting feature, such as a hole or protrusion, can create a thermal resistance area and a possible hot spot in the optic. The methodology can include positioning and placing (and configuring, in the component geometry selection process discussed above, to be positioned and placed) the mounting features in areas of the optic where the mounting features minimize the impact on the overall optic, such as, for example, at the thickest parts of an optical component or optical assembly, including where optical components adjoin or connect.

In implementing the methodology, it may be necessary address competing requirements in certain implementations. For instance, the connection of optics to a housing can have conflicting requirements, such as where it is important to maintain optic symmetry but a single point connection is desired to prevent over-constraining an optical assembly and causing stress. In this regard, the methodology includes selecting, configuring and implementing a single attachment point (for example, for attaching to one optic) that is far away from a heat load and as equidistant from each other optical component in an assembly or structure as possible.

Accordingly, the methodology can provide an optic that provides consistently high accuracy performance and operability under extreme temperature conditions (for example, ranging from below room temperature to at least 1000° C.), including under extreme temperature changes (for example, ranging from 10° C. per second (° C./s) to at least 200° C./s). The methodology can include configuring and assembling the entire optical assembly as a monolithic structure, such that field calibrations and maintenance of the optical components of the assembly are not required after shock, vibration, or due to temperature changes. The methodology can provide an optical assembly that is monolithically constructed and forms the major alignment components of a measurement device (not shown), such as, for example, an interferometer, to facilitate easy and cost-effective maintenance and replacement of the optics within the measurement device.

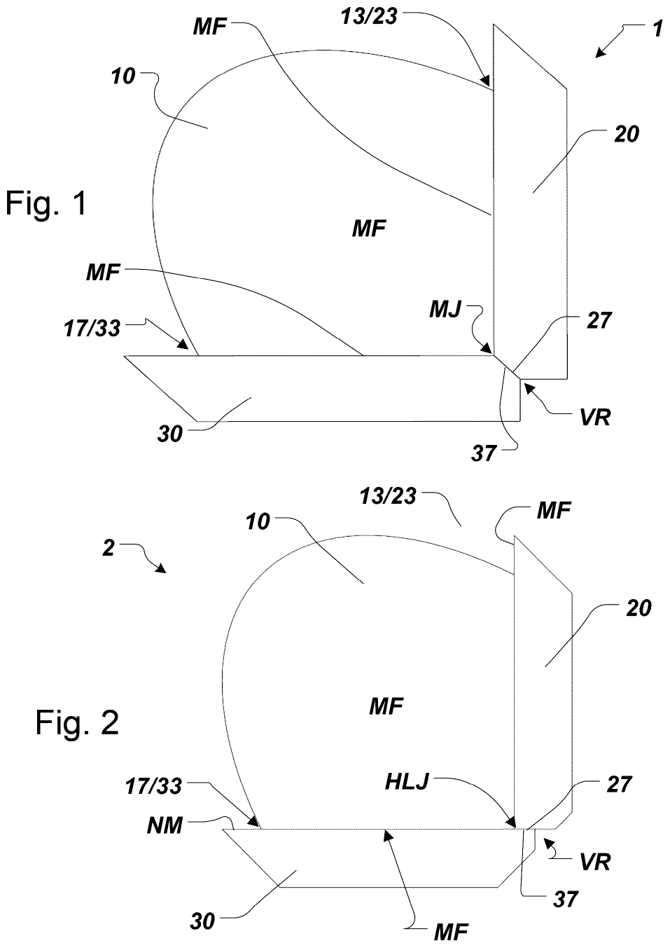

FIG. 1 is an illustration of an optic 1 constructed according to the disclosure. For illustrative purposes, the optic 1 is a retroreflector assembly that can be configured and made, according to the methodology of the instant disclosure, as a monolithic structure of a single material or multiple materials of the same type (for example, materials having substantially the same coefficient of thermal expansion, among other parameters, as disclosed herein).

The optic 1 includes a plurality of mirror panels 10, 20, 30 that are selected and configured, according to the methodology, to adjoin to each for component symmetry via a plurality of respective miter joints (MJ). Each mirror panel 10, 20, 30 has a mirror face (MF) and a pair of connecting regions 13/17, 23/27, 33/37, respectively. Each of the pair of connecting regions is perpendicular to the other and has at least one contact surface configured at a predetermined angle (or angles) with respect to the mirror face MF. The at least one contact surface is configured to adjoin and mate with a corresponding contact surface on the adjoining mirror panel to form a joint, such as, for example, the miter joint MJ seen in FIG. 1. In various embodiments, the contact surfaces can be configured as, for example, beveled surfaces and/or chamfered surfaces with respect to the mirror face of the mirror panel.

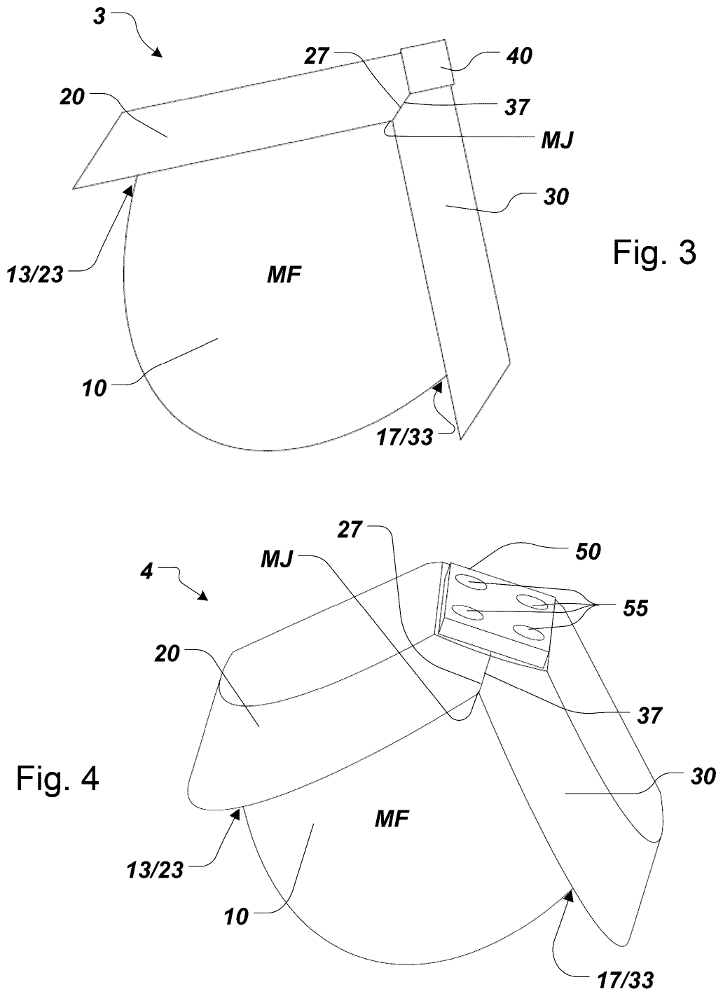

In the embodiment depicted in FIG. 1, the connecting regions 27, 37 each have chamfered contact surfaces, including a beveled contact surface and a non-beveled contact surface, each of which is configured at a predetermined angle with respect to a surface of the mirror face MF. As seen in FIG. 1, the beveled contact surface of the chamfered connecting region 27 is formed at a bevel angle (for example, 45-degrees) with respect to the MF surface of the mirror panel 20; and the beveled surface of the chambered connecting region 37 is formed at a bevel angle (for example, 45-degrees) with respect to the MF surface of the mirror panel 30. The beveled contact surfaces of the chamfered connecting regions 27, 37 are configured such that when the panels 20 and 30 are adjoined along the beveled surfaces of the connecting regions 27/37, the beveled contact surfaces form a miter joint MJ between the panels 20, 30. The non-beveled contact surfaces can be configured to receive and engage a connecting mechanism, such as, for example, the connecting mechanism 40 (shown in FIG. 3). The non-beveled contact surfaces of the chamfered connecting regions 27, 37 are formed at another angle (for example, 90-degrees) with respect to the MF surface of the respective mirror panels 20, 30. It is noted that each pair of the connecting regions 13/23 and 17/33 can be configured exactly the same as the chamfered connecting region pair 27/37, except that connecting regions 13/23 and 17/33 are formed along the lengths of the mirror panels 10, 20, 30, on the sides of the panels not visible in FIG. 1.

In certain embodiments, the connecting regions 13/23, 17/33, 27/37 can each include more than two contact surfaces; and/or, the connecting regions 13/23, 17/33, 27/37 can each include the same or a different geometry, which can be selected from, for example, a beveled contact configuration, a chamfered contact configuration, a half-lap contact configuration, or a butt-joint contact configuration, among others.

The miter joint MJ formed at each of the connecting regions 13/23, 17/33, 27/37 provides component symmetry of each of the mirror panels 10, 20, 30, as well as their overall assembly. The non-miter joint region formed VR by the non-beveled contact surfaces of the chamfered connecting regions 13/23, 17/33, 27/37 can be configured to contact and mate with a connecting mechanism (for example, connecting mechanism 40 in FIG. 4). In certain embodiments, the material at each of the miter joints MJ can be fused together such that the beveled surface of the contact regions 13 and 23 are fused together, as well as the beveled surfaces of the contact regions 17 and 33, and the beveled surfaces of the contact regions 27 and 37 to make the optic 1 as a monolithic structure. Additionally (or in certain embodiments alternatively), where the optic 1 is to be mated with the connecting mechanism, the non-beveled contact surfaces of each pair of the chamfered connecting regions 13/23, 17/33, 27/37 can be fused to the connecting mechanism. Accordingly, either or both the miter joint MJ and non-miter joint VR can be fused, except that in the case of the miter joint MJ, the beveled contact surfaces of each chamfered connecting region 13/23, 17/33, 27/37 are fused to each other; and, in the case of the non-miter joint VR, the non-beveled contact surfaces of each chamfered connecting region 13/23, 17/33, 27/33 are fused to the connecting mechanism.

FIG. 2 is an illustration of an optic 2 having a non-symmetrical joint, constructed according to the principles of the disclosure. In the embodiment depicted in FIG. 2, the optic 2 includes the mirror panels 10, 20, 30 configured to be adjoined to each via a plurality of respective half-lap joints (HLJ). However, in the optic 2, each mirror panel 10, 20, 30 can include the mirror face MF and a non-mirror part (NM) of the mirror face MF, such as, for example, around the perimeter of the polished surface of the mirror panel 10, 20, 30.

In the optic 2, each of the connecting regions can have a chamfered configuration that includes a planar surface and a beveled surface. The planar surface of each contact region can be configured as a flat surface formed at a predetermined angle (for example, 90-degrees) with respect to the mirror face MF of the respective mirror panel 10, 20, 33; and the beveled surface of each contact region can be configured as a flat surface formed a bevel angle (for example, 315-degrees) with respect to the mirror face MF of the respective mirror panel 10, 20, 33.

Each of the connecting regions 17, 23, and 37 can include a planar contact surface that is formed from the non-mirror part NM of the mirror face of the respective mirror panel 10, 20, 30. In at least one embodiment, each of the NM planar contact surfaces of the connecting regions 17, 23, and 37 comprises the non-mirror part NM of the mirror face MF of the respect mirror panel 10, 20, 30. Each NM planar contact surface of the connecting region 17, 23, 37 is configured to adjoin and mate with the corresponding non-beveled contact surface of the respective connecting region 33, 13, and 27 to form a half-lap joint HLJ, as seen in FIG. 2. The non-beveled contact surfaces of the connecting regions 33, 13, and 27 and the non-beveled contact surfaces of the respective connecting regions 17, 23, and 37 (together with the NM planar contact surfaces of the connecting regions 17, 23, and 37) can be configured to form a non-joint portion VR, which in turn can be configured to contact and mate with a connecting mechanism such as, for example, a longitudinal member (not shown) having a triangle-shaped cross-section that matches and mates with the non-beveled contact surfaces in region VR of each connecting region 13/23, 17/33, 27/37.

In at least one embodiment, three connecting mechanisms (not shown) are included in the optic 2. Each of the connecting mechanisms has a length equal to the length of the connecting region 13/23, 17/33, 27/37, and has widths and lengths on two adjoining sides that are equal to the widths and lengths of the respective non-beveled contact surfaces of the region VR formed in the corresponding connecting region 13/23, 17/33, 27/37. It is noted that each of the connecting regions 13/23 and 17/33 forms a region VR that is the same as the region VR formed by the connecting region 27/37, seen in FIG. 2. The optic 2 with three connecting mechanisms can be configured to dissipate (or attain) heat uniformly, without any hot spots developing in the optic 2 as the assembly undergoes extreme temperature variations, such as, for example, when being operated at temperatures below room temperate and immediately being moved into an environment having temperatures in excess of 1,000° C.

In certain embodiments, the material at each of the half-lap joints HLJ can be fused together such that the contact surface of the contact regions 27 and 37 are fused together (as well as the contact surfaces of the contact regions 13 and 23 and the contact regions 17 and 33) to make the optic 2 as a monolithic structure. Additionally (or in certain embodiments alternatively), where the optic 2 is to be mated with the connecting mechanism, the non-beveled contact surfaces of each pair of the chamfered connecting regions 13/23, 17/33, 27/37 can be fused to the connecting mechanism. Accordingly, either or both the half-lap joint HLJ and non-joint region VR can be fused, except that in the case of the half-lap joint HLJ, the contact surfaces of each connecting region 13/23, 17/33, 27 are fused to the contact surfaces of the mirror each other; and, in the case of the non-miter joint VR, the non-beveled contact surfaces of each chamfered connecting region 13/23, 17/33, 27/33 are fused to the connecting mechanism.

In at least one embodiment, the beveled surfaces of the chamfered connecting regions 13/23, 17/33, 27/33 can be attached to a connecting mechanism such as, for example, the connecting mechanism 50 seen in FIG. 4.

FIG. 3 is an illustration of an optic 3, which includes the optic 1 (seen in FIG. 1) and at least one connecting mechanism 40, constructed according to the principles of the disclosure. In at least one embodiment, the optic 3 includes three identical connecting mechanisms 40, each positioned in the non-miter joint region VR formed by the connecting regions 13/23, 17/33, or 27/37, adjacent to the miter joint MJ. Each connecting mechanism 40 can include a longitudinal plate having a square-shaped cross-section with four sides. One of the four sides of the connecting mechanism 40 can be sized to have a width and a length equal to the width and length of the non-beveled contact surface of the connecting region 17, 23, or 37; and an adjacent side can be sized to have a width and a length equal to the width and length of the non-beveled contact surface of the connecting 33, 17, and 27, respectively. The optic 3 (including the optic 1 and three connecting mechanisms 40) can be configured to be symmetric, with each of the mirror panels 10, 20, 30 and the corresponding connecting mechanism 40 being symmetric for uniform heat dissipation or heat attainment, without any hot spots developing in the optic 3 as the assembly undergoes extreme temperature variations, such as, for example, when being operated at temperatures below room temperate and immediately being moved into an environment having temperatures in excess of 1,000° C.

In various embodiments, the connecting mechanism 40 can be fused to one or both of a pair of parallel support members (not shown) to form a monolithic structure comprising an assembly of one or more optical components, including the optic 3. In at least one embodiment, the connecting mechanism 40 can be formed as part of one or both of the pair of parallel support members (not shown).

FIG. 4 is an illustration of an optic 4, including another embodiment of a connecting mechanism 50, constructed according to the principles of the disclosure. In at least one embodiment, the optic 4 includes three identical connecting mechanisms 50, each positioned at the connecting regions 13/23, 17/33, or 27/37, adjacent to and overlapping a miter joint MJ such that one-half of the width of the mechanism 50 is on each side of the miter joint MJ. Each connecting mechanism 50 can include a longitudinal plate having a rectangle-shaped cross-section with four sides, including one side that can be sized to have a length substantially equal to the length of the non-beveled surface of the connecting region 13/23, 17/33, 27/33, and a width substantially equal to the sum of the widths of the non-beveled contact surfaces of the connecting regions 17 and 33, or 13 and 23, or 27 and 37.

In various embodiments, the connecting mechanism 50 can be fused or otherwise attached to the non-beveled contact surfaces of one or both of a pair of parallel support members (not shown) to form a monolithic structure comprising an assembly of one or more optical components, including the optic 4. In at least one embodiment, the connecting mechanism 50 can be formed as part of one or both of the pair of parallel support members (not shown).

In addition to the embodiments of the connecting mechanism having a square-shaped, a triangle-shaped, or a rectangle-shaped cross section, the connecting mechanism can have any shape suitable for the particular application, including, for example, a semicircle shaped cross-section, a circular shaped cross-section, a pentagon shaped cross-section, a hexagon shaped cross section, among others.

In at least one embodiment, the connecting mechanisms 50 can each include two or more holes 55, and each of the mirror panels 10, 20, 30 can include at least one protrusion configured to be received and held in the hole 55. As seen in FIG. 4, the connecting mechanism 50 can include four holes 55, of which a set of two holes 55 on either side of the miter joint MJ is configured to receive and hold corresponding protrusions on the respective mirror panel 20 or 30, such that both mirror panels 20, 30 are fastened to the connecting mechanism 50 by the holes 55. It is noted that the two other connecting mechanisms (not shown) can have identical structures and identical holes 50 to receive and hold corresponding protrusions on the mirror panels 10 and 20, and the mirror panels 10 and 30.

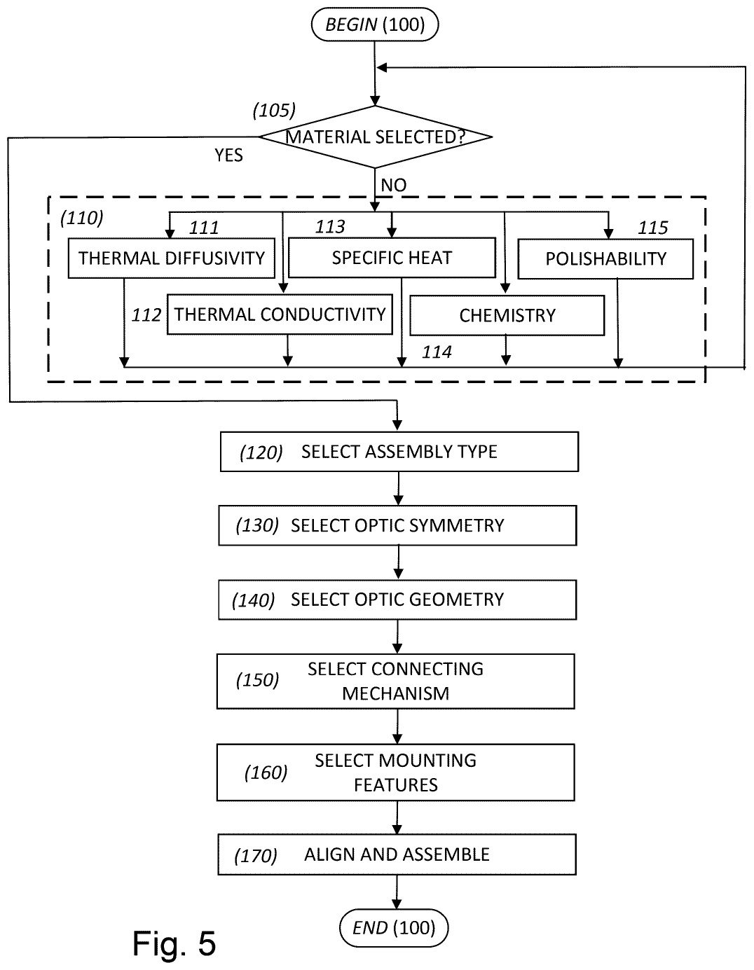

FIG. 5 is an illustration of a process 100 for making an optic according to the principles of the disclosure. The process 100 can be implemented to make, for example, any of the optics 1-4 seen in FIGS. 1-4, respectively. Initially, a determination is made whether a material been selected for an optic. If it is determined that a material has not be selected (NO at Step 105), then the material appropriate for the particular application and environment is determined (Step 110). The selection of the particular material (Step 110) includes a plurality of determinations, depending on the applications and environments in which the optic will be used, including the rates of temperature changes the optic will experience, a determination can be made regarding the specific value or range of values. A series of determinations can be made for each possible material that can be used in the optic, including an analysis for each characteristic (or parameter) of the material, including, but not limited to, the thermal diffusivity (Step 111), thermal conductivity (Step 112), specific heat (Step 113), chemical reactivity at high temperature (Step 114), and polishability of the material to an optical finish (Step 115). Certain applications may require additional parameters to be determined. The Steps 111 to 115 can be performed in parallel, or sequentially, and repeated until at least one material is selected (YES at Step 105).

In the embodiments depicted in FIGS. 1-4, Steps 105 and 110 can be repeated for each material to be used in the optic 1, 2, 3, or 4, including each mirror panel 10, 20, 30, and, in the case of optics 3 and 4, the connecting mechanism 40, 50. The Steps 105 and 110 can be repeated until materials are selected having matching or substantially equal coefficients of thermal expansion. For example, in the embodiments depicted in FIGS. 1-3, the same material can be selected for each of the mirror panels 10, 20, 30, and the connecting mechanism 40.

In at least one of the embodiments of the optic 1 (shown in FIG. 1), optic 2 (shown in FIG. 2), optic 3 (shown in FIG. 3), or optic 4 (shown in FIG. 4), a material such as glass can be selected having: a thermal diffusivity in the range of, for example, 0.5 to 3.7×10⁻⁶ m2/sec; a thermal conductivity in the range of, for example, 1.1 to 41 W/m*K; a specific heat in the range of, for example, 750 to 1050 J/Kg*K; and that can be polished to a value of, for example, λ/10 flatness.

After the material characteristics and material are selected for the optic (YES at Step 105), an assembly type can be selected (Step 120). For instance, a monolithic structure can be selected for applications or environments having extreme temperatures (for example, in excess of 1,000° C.) or temperature changes (for example, in excess of 100° C./s). As noted earlier, assembly to withstand elevated temperatures is tricky since as temperature changes, components such as fasteners will expand or contract, thereby changing clamping force on the part and can work loose. In selecting the monolithic structure type, the parts of the optic can be fused to each other or to a common support to become a complete monolithic assembly. This eliminates standard fasteners such as screws or retaining rings. The material fusion may be discrete spots along joining edges or may be a continuous line.

Next, a configuration of the optic or its parts can be selected with respect to symmetry, which can be selected to minimize, for example, thermal gradients in the optic (Step 130). At high temperatures, differences in geometry can affect the heat flow in and out of the optic, causing significant differences in temperature that the optic can attain. To minimize different rates and degrees of thermal expansion (or contraction) and, thus, stress and deformation of the optic, each of the parts can be selected to achieve overall symmetry of the optic. For example, the optic 1 (shown in FIG. 1) or optic 3 (shown in FIG. 3) are made with the mirror panels 10, 20, 30 and/or the connecting mechanisms 40 having symmetrical structures that are fused to each other at the miter joints MJ and the connecting regions, thereby providing an optic having overall symmetry.

As a further extension of, or after, the optic symmetry selection (Step 130), the geometry of each feature of the optic is selected (Step 140). Referring to, for example, the mirror panels 10, 20, 30 in optics 1-4 (shown in FIGS. 1-4, respectively), the mirror panels can be configured to meet up in a variety of geometries, including a preferred implementation having the mating faces be at a 45-degrees angle to the polished surfaces of the mirror faces. Depending on the application or environment, or the assembly, in which the optic will operate, any of a variety of geometries can be selected for the optic, including, for example, a miter joint (MJ, seen in FIGS. 1, 3, 4), a half-lap joint (HLJ, seen in FIG. 2), a butt-joint, or other geometry.

With the assembly type (Step 120), the optic symmetry (Step 130), and the optic geometry (Step 140) having been selected, it may be determined that one or more connecting mechanisms are to be selected (Step 150). For instance, in the case of the monolithic structure type, one or more support members may be necessary to secure and hold the optic in the assembly. In at least one embodiment, a pair of flat planar plates can be included in the assembly, with each of the plates configured to secure and hold an opposing side of the optic, sandwiching the optic between the plates. The flat planar plates can be made of the same material as the optic and, in certain embodiments, fused to the optic.

In the embodiment of the optic 3 (shown in FIG. 3) or the optic 4 (shown in FIG. 4), the connecting mechanisms 40 and 50, respectively, can be selected in Step 150, including the dimensions and geometry of the connecting mechanism.

In step 150, a determination can be made regarding positioning and placement of the connecting mechanism, including, for example, placement of the connecting mechanism 40, 50 in specific areas in the optics 3 and 4, respectively, to promote heat transfer and minimize thermal gradients. The connecting mechanism 40, 50 need not be structural components but can be included for helping to achieve thermal equilibrium in the optic.

The assembly type (Step 120), optic symmetry (Step 130), optic geometry (Step 140), and connecting mechanisms (Step 150) having been determined and selected, one or more mounting features can be selected (Step 160). For instance, mounting features such as holes (threaded or otherwise) and protrusions can be selected in this step, such as, for example, for interfacing portions of the optic to each other, or for interfacing portions of the optic to structures in the assembly such as, for example, the support plates (not shown) discussed above. The mounting features can include fusion of materials. Referring to the optic 4 (shown in FIG. 4), a plurality of holes 55 can be selected for machining in, or formation with, the connecting mechanism 50, as well as for the formation of the corresponding protrusions on the mirror panels 10, 20, 30, as discussed above with reference to FIG. 4. The types and locations of the mounting features are selected to avoid possible hot spots, such as, for example, hot spots caused by a thermal resistance at one or more of the mounting holes. At Step 160, placement can be selected to place the mounting features in areas where they minimize the impact on the optic or overall assembly in which the optic is included, such as, for example, placing the mounting features in the thickest parts of the assembly (for example, the planar supports discussed above) and where panels meet, as seen in FIG. 4.

Once the assembly type (Step 120), optic symmetry (Step 130), optic geometry (Step 140), connecting mechanisms (Step 150), and mounting features (Step 160) are determined and selected the optic can be aligned and assembled (Step 170). For example, referring to FIG. 3, each of the mirror panels 10, 20, 30 can be optically aligned so that each mirror face MF of each panel is exactly 90-degrees with respect to the mirror face MF of each of the other two adjoining panels. In certain embodiments, the optical alignment of any one or more of the mirror panels 10, 20, 30 can have an angular deviation (or tolerance) in the range of, for example, +0.01 to +1×10−5 degrees. With the panels 10, 20, 30 in exact alignment, the connecting regions 13/23, 17/33, and 27/37 can be fused to each other at each miter joint MJ and/or to the sides of the connecting mechanism 40 by fusing the materials to each other.

The FIGS. 1-4 included in this specification are for illustrative purposes and it is understood that the disclosure, including the methodology, can be employed to design, configure, assemble, and/or make various optics and combinations of optics, including optical components and optical assemblies such as mirrors, lenses, retroreflectors, prisms, supports, mounts, mounting features, connecting mechanisms, and combinations of the foregoing, including as a single monolithic structure containing any combination of the foregoing, preassembled and optically aligned.

The terms “a,” “an,” and “the,” as used in this disclosure, means “one or more,” unless expressly specified otherwise.

The terms “including,” “comprising” and variations thereof, as used in this disclosure, mean “including, but not limited to,” unless expressly specified otherwise.

References in the disclosure to “one embodiment,” “an embodiment,” “an example embodiment,” or “example,” indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format can be interpreted in a flexible manner to include not only the numerical values explicitly recited as the limits of the range, but also to include all the individual numerical values or sub-ranges encompassed within that range as if each numerical value and sub-range is explicitly recited.

The term “or” is used to refer to a nonexclusive “or” unless otherwise indicated. Unless indicated otherwise, the statement “at least one of” when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G: F and G; D, E, and F; D, E, and G; D, F, and G; E, F, and G; or D, E, F, and G.” A comma can be used as a delimiter or digit group separator to the left or right of a decimal mark; for example, “0.000,1″” is equivalent to “0.0001.”

Although process steps, method steps, or the like, may be described in a sequential or a parallel order, such processes and methods may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes or methods described herein may be performed in any order practical.

When a component, article, or assembly of components or articles 1 is described herein, it will be readily apparent that more than one component or article may be used in place of a single component or article. Similarly, where more than one component or article is described herein, it will be readily apparent that a single component or article may be used in place of the more than one component or article. The functionality or the features of a component or article may be alternatively embodied by one or more other components or articles that are not explicitly described as having such functionality or features.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. A method for making an optic that is operable in extreme temperature environments, the method comprising:
selecting a material for each of a plurality of mirror panels based on a parameter comprising at least one of a thermal diffusivity, a thermal conductivity, a specific heat, chemistry, and polishability;
selecting a type of assembly of an optic;
selecting a geometric configuration for each of the plurality of mirror panels;
aligning optically each of the plurality of mirror panels; and
assembling each of the plurality of mirror panels in optical alignment such that each mirror panel is within a predetermined angular tolerance,
wherein the assembling further comprises fusing the material of at least one of the plurality of mirror panels to make the optic of the selected type of assembly.

2. A method for making an optic that is operable in extreme temperature environments, the method comprising:
selecting a material for each of a plurality of parts of an optic based on a parameter comprising at least one of a thermal diffusivity, a thermal conductivity, a specific heat, chemistry, and polishability;
selecting a type of assembly of the optic;
selecting a geometric configuration for each of the plurality of parts of the optic;
aligning optically each of the plurality of parts of the optic; and
assembling each of the plurality of parts of the optic in optical alignment such that each part is within a predetermined angular tolerance,
wherein the assembling further comprises fusing the material of at least one of the plurality of parts of the optic to form the selected type of assembly of the optic.

3. The method of claim 2, wherein each of the plurality of parts of the optic has a joining edge.

4. The method of claim 3, wherein the fusing comprises a continuous fused line along the joining edge of the at least one of the plurality of parts.

5. The method of claim 3, wherein the fusing comprises one or more discrete fused spots along the joining edge of the at least one of the plurality of parts.

6. The method of claim 2, wherein the selected type of assembly is a monolithic structure.

7. The method of claim 6, wherein the assembling further comprises fusing the material of the at least one of the plurality of parts of the optic to form the monolithic structure.

8. The method of claim 2, wherein:
each of the plurality of parts of the optic has a joining edge;
the selected type of assembly is a monolithic structure; and
the assembling further comprises fusing the material of each of the plurality of parts of the optic at the joining edge to form the monolithic structure.

9. The method of claim 2, wherein the material is selected based on the thermal diffusivity, the thermal conductivity, the specific heat, the chemistry, and the polishability.

10. The method of claim 2, wherein the at least one of the plurality of parts of the optic comprise a connecting mechanism.

11. The method of claim 10, wherein the connecting mechanism comprises a connecting plate having a square-shape cross section.

12. The method of claim 10, wherein the assembling further comprises fusing a joining edge of the connecting mechanism to another part of the plurality of parts of the optic to form the selected type of assembly of the optic.

13. The method of claim 10, wherein the connecting mechanism comprises a connecting plate having a rectangular-shape cross section.

14. The method of claim 13, wherein the connecting plate includes a plurality of mounting features.

15. The method of claim 3, wherein the joining edge includes a beveled contact surface.

16. The method of claim 3, wherein the joining edge includes a non-beveled contact surface.

17. The method of claim 16, wherein the non-beveled contact surface includes a non-mirror portion of a first one of the plurality of parts of the optic.

18. The method of claim 17, wherein the first one of the plurality of parts of the optic is a mirror panel.

19. The method of claim 18, wherein the plurality of parts comprises three mirror panels, including said mirror panel.

20. The method of claim 16, wherein the first one of the plurality of parts of the optic is a mirror panel and the non-beveled portion comprises a planar contact surface perpendicular to a mirror face of the mirror panel.
